(19) United States
(12) Patent Application Publication
(10) Pub. No.: US 2006/0241923 A1
(43) Pub. Date: Oct. 26, 2006

(54) Automated systems and methods for generating statistical models

(75) Inventors: Cheng (Kenneth) Xu, Glen Allen, VA (US); Peter James Wachtell, Boise, ID (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Capital One Financial Corporation

(21) Appl. No.: 11/415,427

(22) Filed: May 2, 2006

Related U.S. Application Data
(63) Continuation of application No. 10/209,905, filed on Aug. 2, 2002.

(51) Int. Cl. G06F 17/10

(52) U.S. Cl. 703/2

(57) ABSTRACT

Systems and methods are disclosed for generating statistical models. Such systems and methods may utilize a database comprising data representing a plurality of variables. To generate a statistical model, a set of variables may be selected in accordance with a goal of the model. Using the database, the selected set of variables may then be applied to a plurality of statistical model types and the results from each statistical model type may be analyzed. Finally, at least one of statistical model may be identified based on the analysis of the results.

### BACKGROUND OF THE INVENTION

I. Field of the Invention

The present invention generally relates to statistical modeling and data processing. More particularly, the invention relates to automated systems and methods for generating statistical models, including statistical models used for processing and/or analyzing data.

II. Background Information

Statistical models are used to determine relationships between dependent variable(s) and one or more independent variables. For example, a statistical model may be used to predict a consumer's likelihood to purchase a product using one or more independent variables, such as a consumer's income level and/or education. Statistical models can also be used for other purposes, such as analyzing interest rates, predicting the future price of a stock or estimating risk associated with consumer loans or financing.

Generally, independent variables selected for a statistical model will have some relationship or correlation to the dependent variable(s). Further, some variables may be found to have a greater relationship or correlation with a dependent variable. For instance, to predict a consumer's likelihood to purchase a product, independent variables such as the consumer's income level or education may be more significant than other variables. Moreover, certain types of statistical models (such as regression models or parametric models) may prove to be more useful than other models for determining a dependent variable, which can vary depending on the objective or goal of the model.

Using traditional approaches, the task of developing a statistical model for a given objective is often an arduous and time consuming process. Not only must the appropriate independent variables be selected, but also the most effective model types need to be identified and employed to yield good results. Repetitive trials of different model types and sets of variables are often required before a suitable model can be developed or identified.

In a business environment, it is often found that the need to produce and refresh statistical models is large. For instance, statistical models are frequently employed to shape or guide market strategies or business development. Traditional model building processes, however, can not fulfill these needs quickly. Statisticians often follow textbook examples to build models one by one. Further, most statisticians do not utilize the advantages of modern technology to enhance statistical model building.

### SUMMARY OF THE INVENTION

In accordance with embodiments of the invention, systems and method are provided for generating statistical models. Generally, such systems and methods overcome the disadvantages of traditional model building and generate statistical models more quickly and with better quality. Further, embodiments of the invention provide an automated approach to statistical model building by taking advantage of modern technology, including computer-based technology and modern data storage and processing capabilities. Embodiments of the invention also provide suitable model refreshing capabilities that permit businesses to adopt new strategies more rapidly. Additionally, embodiments of the invention may be adapted to concurrently analyze a plurality of model types based on an identified goal, and/or construct segments of data from a data mart and build models for each segment.

Consistent with embodiments of the invention, methods are provided for generating statistical models. Such methods may include: providing a database comprising data representing a plurality of variables; selecting a set of variables in accordance with an objective; applying the selected set of variables based on the data from the database to a plurality of statistical model types; analyzing the results for each statistical model type; and identifying at least one of the statistical model based on the analysis of the results.

In accordance with additional embodiments of the invention, systems are also provided for generating statistical models. Such systems may include: a database comprising data representing a plurality of variables; a statistical model generator to generate statistical models; and a user interface to receive data and provide output. The statistical model generator may include means for applying a set of selected variables, based on the data from the database, to a plurality of statistical model types; means for analyzing the results for each statistical model type; and means for identifying at least one of the statistical model based on the analysis of the results.

Embodiments of the invention also relate to computer readable media that include program instructions or program code for performing computer-implemented operations to provide methods for generating statistical models. Such computer-implemented methods may include: selecting a set of variables in accordance with an objective; applying the selected set of variables based on the data from a database to a plurality of statistical model types; analyzing the results for each statistical model type; and selecting at least one of the statistical model based on the analysis of the results.

It is to be understood that both the foregoing general description and the following detailed description are exemplary only, and should not be deemed restrictive of the full scope of the embodiments of the invention, as claimed herein.

### BRIEF DESCRIPTION OF THE DRAWINGS

The accompanying drawings, which are incorporated herein and constitute a part of this specification, illustrate various features and aspects of embodiments of the invention. In the drawings:

FIG. 1 illustrates an exemplary system environment for generating statistical models, consistent with embodiments of the invention;

FIG. 2 illustrates an exemplary statistical model generator, consistent with embodiments of the invention;

FIG. 3 illustrates a flowchart of an exemplary method for generating statistical models, consistent with embodiments of the invention;

FIG. 4 illustrates a flowchart of another exemplary method for generating statistical models, consistent with embodiments of the invention;

FIG. 5 illustrates a flowchart of an exemplary method for applying a statistical model type, consistent with embodiments of the invention;

FIG. 6 illustrates a flowchart of an exemplary method for analyzing results to identify statistical models, consistent with embodiments of the invention;

FIG. 7 illustrates a flowchart of an exemplary method for generating models from data organized into segments, consistent with embodiments of the invention; and

FIG. 8 illustrates a flowchart of an exemplary method for refreshing models, consistent with embodiments of the invention.

### DETAILED DESCRIPTION

Embodiments of the present invention may be implemented in various systems and/or computer-based environments. Such systems and environments may be adapted to generate statistical models that are consistent with identified goal(s) or objective(s). Consistent with embodiments of the invention, such systems and environments may be specifically constructed for performing various processes and operations, or they may include a general purpose computer or computing platform selectively activated or reconfigured by program code to provide the necessary functionality.

The exemplary systems and methods disclosed herein are not inherently related to any particular computer or apparatus, and may be implemented by suitable combinations of hardware, software, and/or firmware. For example, various general purpose machines may be used with programs written in accordance with the teachings of the invention, or it may be more convenient to construct a specialized apparatus or system to perform the required methods and techniques.

Embodiments of the present invention also relate to computer readable media that include program instructions or program code for performing various computer-implemented operations based on the exemplary methods and processes disclosed herein. The media and program instructions may be specially designed and constructed, or they may be of the kind well-known and available to those having skill in the computer software arts. Examples of program instructions include both machine code, such as produced by a compiler, and files containing a high level code that can be executed by the computer using an interpreter.

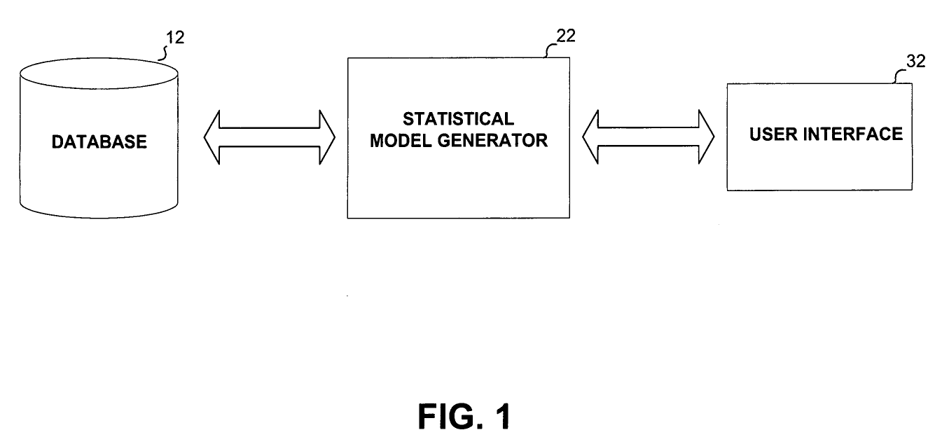

FIG. 1 illustrates an exemplary system environment for implementing embodiments of the invention. The system environment of FIG. 1 may be practiced through any suitable combination of hardware, software and/or firmware. Further, as can be appreciated by those skilled in the art, the environment of FIG. 1 may employ either a centralized or distributed architecture for storing, processing, analyzing and/or communicating data. Additionally, one or more components of FIG. 1 may be implemented through software-based modules that are executed by a computer, such as a personal computer or workstation.

As shown in FIG. 1, the operating environment may include a database 12, a statistical model generator 22, and a user interface 32. These components may be interconnected or integrated with one another to facilitate the transfer, analysis and/or communication of data. As can be appreciated by those skilled in the art, the illustration of FIG. 1 is intended to be exemplary. Thus, while only one database 12 is illustrated in FIG. 1, any number of databases may be provided. Moreover, although only one statistical model generator 22 and one user interface 32 is illustrated in FIG. 1, these components can be provided in any number or quantity, depending on the needs and requirements of the system environment or user. In addition, as those skilled in the art can appreciate, embodiments of the invention may be practiced in other environments, such as environments incorporating multi-processors, hand-held devices, Web-based components and networked computers or mainframes.

Database 12 may be implemented as a database or collection of databases to store data. To collect data for storage, database 12 may be provided with a data collection module or interface (such as network interface—not shown in FIG. 1) to gather data from various sources. To store data, database 12 may be implemented as a high density storage system. As can be appreciated by those skilled in the art, various database arrangements may be utilized to store data in database 12, including relational or hierarchical database arrangements. In one embodiment, database 12 may be configured to store large quantities of data as part of a data warehouse or a large-scale data mart. Further, in another embodiment, historical data is stored in database 12 to facilitate the development of models consistent with identified objective(s) or goal(s). Moreover, by storing large quantities of data, database 12 may become more robust and facilitate the process of building a wider variety of statistical models for a user, such as an entity or organization.

Depending on the scope and type of statistical models to be generated, various types of data may be stored in database 12. Further, database 12 may store data collected from one or more sources. By way of non-limiting examples, the data stored in database 12 may be data from public data sources such as tax, property and/or credit reporting agencies. Data from proprietary and/or commercial databases may also be used, as well as internal or historical data collected by a business entity or other types of organizations. Such data may relate to demographic or economic data. Also, the data may include sales or transaction data of consumers, indicating purchasing trends or other types of consumer activity. For company specific data, the data may indicate sales trends, as well as company-wide losses or profits.

In accordance with an embodiment of the invention, the data stored in database 12 may come in one or more data forms, such as cross section, time-series, panel and/or other conventional data forms. Data representing combinations of these forms is also possible, such as data that is a combination of cross section and time-series data, sometimes referred to as longitudinal data. Statistical methods and techniques performed by the system environment of FIG. 1 may be specifically developed or adapted for each of the different data forms present in database 12. For purposes of illustration, exemplary methods and techniques for handling cross section data are disclosed herein. However, as can be appreciated by those skilled in the art, similar methods and techniques may be developed and incorporated into the invention to handle other data forms, such as time-series and panel data.

Statistical model generator 22 may be adapted to generate statistical models based on data stored in database 12. Statistical model generator 22 can be maintained by a specific entity or group of entities, or may be maintained by a service provider who generates and provides statistical models to customers as part of a service (such as a Web-based service that generates statistical models according to stated goals or objectives).

Statistical model generator 22 may be implemented as a computer-based component comprising one or more software-based modules. In operation, statistical model generator 22 may assess various combinations of variables and model types in accordance with the stated goal(s) for the model to be generated. Further, by applying the data stored in database 12, statistical model generator 22 may identify one or more statistical model(s) that are best suited for the stated goal(s).

In one embodiment, statistical model generator 22 may be implemented to process and generate multiple models at a time. In another embodiment, statistical model generator 22 may be equipped with model refreshing capabilities in order to reassess or refresh specific models based on updated data stored in database 12. Further, in still another embodiment of the invention, statistical model generator 22 may be adapted to construct segments of data and generate statistical model(s) for each segment.

Referring again to FIG. 1, user interface 32 may be provided to facilitate data entry and output with statistical model generator 22. For example, with user interface 32, a user may provide data indicating the goal(s) or objective(s) of a model to be generated by statistical model generator 22. The model and other output generated by statistical model generator 22 may also be communicated to a user by way of user interface 32. Although not illustrated, user interface 32 may also provide an interface with database 12 to facilitate data entry and retrieval with database 12.

As can be appreciated by those skilled in the art, user interface 32 may be implemented using one or more conventional user interface devices. Such devices include input/output (I/O) devices such as a keyboard, a mouse, a display screen (such as a CRT or LCD), a printer and/or a disk drive. In accordance with an embodiment of the invention, user interface devices can be connected to statistical model generator 22 and/or database 12, or such devices may be provided as part of a personal computer, workstation or hand-held device that is connected or networked with statistical model generator 22 and/or database 12.

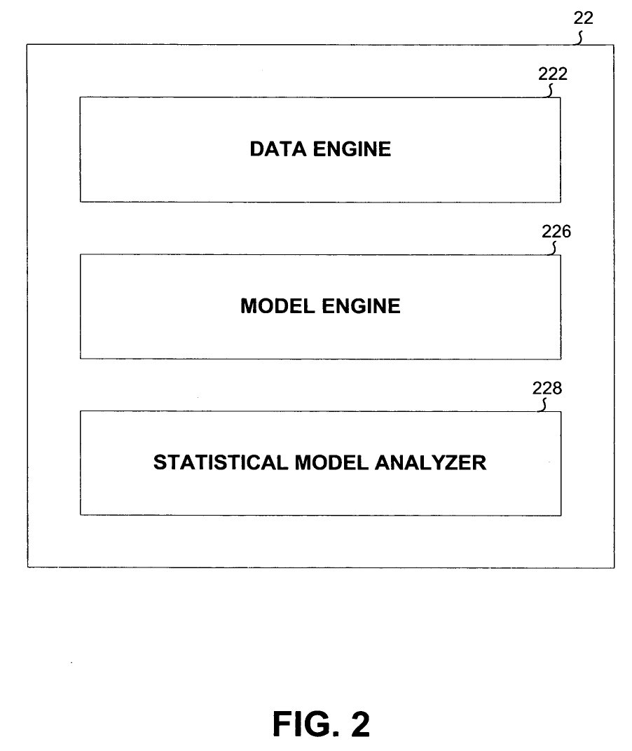

FIG. 2 illustrates an exemplary block diagram of statistical model generator 22. As shown in FIG. 2, statistical model generator 22 may include a number of modules, such as a data engine 222, a model engine 226 and a statistical model analyzer 228. These modules may be created as software-based modules that are executed on a computer or microprocessor-based platform, such as a server, mainframe, personal computer, workstation or hand-held device. While FIG. 2 illustrates these modules as separate components, the modules may be provided in any combination or may be implemented as part of a single computer program product. Further, other modules or components may be provided as part of statistical model generator 22, such as modules for interfacing with system components, including database 12 and/or user interface 32.

Consistent with an embodiment of the invention, data engine 222 may be provided for handling, preparing and processing data stored in database 12. For example, data engine 222 may process and clean data stored in database 12 and prepare the data for further analysis. For instance, data collected and stored in database 12 may represent large quantities of demographic, financial, non-financial and/or other types of data collected from various sources. Such raw data may not be optimized for statistical analysis and model building. Therefore, data engine 222 may analyze the data and clean the same for the purposes of resolving missing or extreme data. As can be appreciated by those skilled in the art, conventional data processing techniques may be used to clean the data, such as data imputation techniques or extrapolation methods. Using such techniques, data engine 222 may impute missing data and eliminate extreme data. Data engine 222 may also perform other data preparation steps, such as transforming variables, creating new variables and/or coding independent variables. Further, by processing and cleaning the stored data, data engine 222 may construct a large-scale data mart in database 12.

Model engine 226 may be adapted to perform various tasks related to building models. For example, in accordance with one embodiment, model engine 226 may identify or select variables for building statistical models. To select variables, model engine 226 may first perform a variable reduction routine to eliminate statistically redundant data, etc. in database 12. For variable reduction, conventional techniques may be used, such as factor analysis, principal component and variable clustering. After eliminating any correlated or redundant variables, model engine 226 may identify the most relevant variables for each model type analyzed. Stepwise methods or other conventional techniques may be employed by model engine 226 to select the most relevant variables. For information concerning stepwise techniques, see, for example: Costanza, M. and Afifi, A. A., “Comparison of Stopping Rules in Forward Stepwise Discriminant Analysis,” Journal of the American Statistical Association, Vol. 74, No. 368, pp. 777-785 (December 1979); and Welsch, R., “Stepwise Multiple Comparison Procedures,” Journal of the American Statistical Association, Vol. 72, No. 359, pp. 566-575 (September 1977).

The selected variables may represent one or more independent variables of a model that generates dependent variable(s), consistent with an identified objective or goal for the model. Thus, for example, if the goal of the model is to analyze the likelihood of a consumer to purchase a product, the independent variables selected by model engine 226 may include a consumer's address, education, marital status and/or income. Such independent variables may be represented by data stored in database 12. By applying data representative of the independent variable(s) to the statistical model, data corresponding to the dependent variable(s) may be generated by the model.

As illustrated in FIG. 2, statistical model analyzer 228 is another component that may be provided as part of statistical model generator 22. Based on the independent variables identified by model engine 226, statistical model analyzer may apply data from database 12 to one or more different model types. As can be appreciated by those skilled in the art, various conventional statistical models may be analyzed with data, such as regression models (including linear regression models such as partial least squares (PLS) models, and non-linear regression models such as logistic regression models), parametric models, non-parametric models (such as growth models), tree type models or analysis, and neural network-based models. In one embodiment, a large set of different model types are tested by statistical model analyzer 228 to provide more robust results and to enhance the probability of identifying a model that is best suited for the goal(s) of the model.

To identify the best model, the results of the models may be analyzed by statistical model analyzer 228. In one embodiment, statistical model analyzer may apply one or more benchmark measurements or diagnostic statistics to determine the performance of each model. As can be appreciated by those skilled in the art, conventional benchmark tests or criteria may be applied such as R², Akaike's information criteria (AIC) and/or Bayesian information criteria (BIC). Additionally, or in the alternative, statistical model analyzer 228 may analyze the accuracy of the model depending on the stated objective(s) or goal(s) for the model. For example, if the object of the model is to provide some type of forecast or prediction, the error of the model with respect to predicted versus actual values may be computed using, for instance, the following relationship: Error=|(Predicted−Actual)/Actual|.

For information concerning various techniques for analyzing models, see, for example: Ducharme, G., “Consistent Selection of the Actual Model in Regression Analysis,” Journal of Applied Statistics, Vol. 24, No. 5, pp. 549-558 (1997); Aerts, M., Claeskens, G. and Hart, J., “Testing the Fit of a Parametric Function,” Journal of the American Statistical Association, Vol. 94, No. 447, pp. 869-879 (September 1999); and Anderson, D. R., Burnham, K. P. and White, G. C., “Comparison of Akaike Information Criterion and Consistent Akaike Information Criterion for Model Selection and Statistical Inference from Capture-Recapture Studies,” Journal of Applied Statistics, Vol. 25, No. 2, pp. 263-282 (1998). Further, by way of non-limiting examples, Table 1 provides examples of conventional benchmark tests and criteria that may be used for analyzing models.

TABLE 1
Model Fit and Diagnostic Statistics

| | |
|---|---|
| $SST = \sum ( {Y}_{i} - {\overline{Y}}^{2} )$ | Total sum of squares |
| $SSE = {\sum }_{i = 1}^{n} {( {Y}_{i} - {\hat{Y}}_{i} )}^{2}$ | Error sum of squares |
| ${R}^{2} = 1 - \frac{SSE}{{SST}_{i}}$ | |
| $AIC = nln ( \frac{SSE}{n} ) + 2 p$ | Akaike's information criteria |
| $BIC = nln ( \frac{SSE}{n} ) + 2 ( p + 2 ) q - 2 {q}^{2} where q = \frac{{\hat{s}}^{2}}{SSE}$ | Sawa's Bayesian information criteria |

where:
n = the number of observations
p = the number of parameters including the intercept

Depending on the object of the model, various other metrics (such as false-negative ratios or false-positive ratios) may be used by statistical model analyzer 228 to gauge the performance of the model. By way of a non-limiting example, assume for instance that the object of the model is to predict an event such as charge-off or bankruptcy. In such a case, the performance of the model may be gauged according to sensitivity (i.e., the ability to predict an event correctly) or specificity (i.e., the ability to predict a nonevent correctly). The sensitivity of a model may be determined by analyzing the proportion of event responses that were predicted to be events. The specificity of the model could be determined by analyzing the proportion of non-event responses that were predicted to be non-events.

Consistent with an embodiment of the invention, statistical model analyzer 228 may rank each of the tested models according to the performance and/or accuracy of the model. In one embodiment, ranking may be performed by considering both the performance and accuracy of each model. Various scoring methodologies could be applied to compute a total score for each model. In such cases, certain measurements (such as the accuracy of the model with respect to a business goal) may be weighed higher than other measurements (such as performance of the model with respect to statistical goals). The model that receives the top ranking could then be identified to the user (using, for example, user interface 32 in FIG. 1). Alternatively, a predetermined number of the top ranked models (such as the three highest ranked models) could be identified to the operator or user. This could facilitate manual review of the results so that the final model is ultimately selected using, for example, the skill or experience of a statistician or user.

As can be appreciated by those skilled in the art, various hardware and software may be utilized to implement the embodiments of FIGS. 1 and 2. For instance, for storing data (such as in database 12) and running software-based modules or engines (such as the components illustrated in FIG. 2), various UNIX boxes and mainframe servers may be employed. Further, the operating system(s) can vary according to the hardware equipment that is utilized in the system environment. Various conventional software packages can also be used alone or in combination for performing specific statistical functions and analysis. Such conventional software packages include SAS, SPSS, and S+. In order to perform functions related to the automated modeling processes of the present invention, SAS may be used in view of its advantages, ability to code easily, and large data processing capabilities. However, SAS is not a requirement, and other software packages and/or independently develop programs can be used. Further, in certain circumstances, there may be a need to run millions of models against large databases and, accordingly, the speed for completing each modeling run may become a significant concern. As a result, basic language packages, such as C, C+, C++, may be used in order to increase software performance and reduce run time.

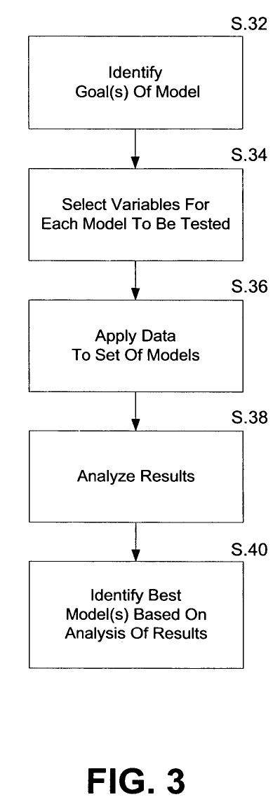

FIG. 3 is a flowchart of an exemplary method for generating statistical models, consistent with embodiments of the invention. The exemplary method of FIG. 3 may be implemented using the system environment and exemplary components of FIGS. 1 and/or 2. As can be appreciated by those skilled in the art, however, the exemplary method of FIG. 3 may be implemented in other system environments and platforms to generate statistical models.

As illustrated in FIG. 3, in order to generate a statistical model, the goal(s) of the statistical model is first identified (step S.32). The goal(s) of the model may be entered through an interface, such as user interface 32 (FIG. 1). Each model to be generated may have one or more goals or objectives that are related to the dependent variable(s) of the statistical model. Such goals or estimates may be the ability to forecast or predict an outcome or event. For example, a statistical model may have a goal or objective such as providing an estimate of whether a consumer will purchase a product or predicting the likelihood that a consumer will default on a loan or credit card account. In accordance with an embodiment of the invention, the types of goals or objectives may be limited or restricted based on various factors, such as the type of historical data provided in database 12 and the ability to generate models from such data. For example, according to one embodiment, database 12 may be limited to storing data that is pertinent to a particular field or sector (such as the financial industry or retail sector) and, thus, limit the types of goals or objectives that can be entered by a user. In other embodiments, database 12 may store data relevant to many different industries or sectors and, thus, permit a wider range of models to be generated for a user.

Once the goal(s) for a model are identified, the independent variables may be selected for each model type to be tested (step S.34). As part of this step, all variables that are found to be significant to the objective or goal of a model may be selected using, for example, model engine 226 of statistical model generator 22 (FIGS. 1 and/or 2). In one embodiment, different goals or objectives may be categorized and set(s) of variables may be correlated with each category of goals. In such a case, based on input from the user, set(s) of variables may be selected according to the goals or objectives identified by the user.

Other techniques and processed may be employed by model engine 226 to select variables for building statistical models. For example, as indicated above, model engine may first perform a variable reduction routine and then select relevant variables for each model to be tested (such as logistic regression, tree analysis, neural network, etc.). Variable reduction may be performed to eliminate statistically redundant data, etc. through conventional techniques, such as factor analysis, principal component and variable clustering. Model engine 226 may then identify the most relevant variables for each model analyzed. Stepwise methods or other conventional techniques may be employed by model engine 226 to select the most relevant variables.

Based on the selected independent variables, data is applied to the set of models to be tested (step S.36). Data, representing the selected variables, may be applied from database 12 by statistical model analyzer 228. In one embodiment, the data stored in database 12 represents historical data that is prepared by data engine 222 before being applied by model analyzer 228. As part of this data preparation step, the historical data in database 12 may be cleaned and organized in a predetermined arrangement, such as a large-scale data mart. The prepared data may then be applied to a set of different models by statistical model analyzer 228 to identify the best-suited model(s) for the stated goal(s) or objective(s).

As can be appreciated by those skilled in the art, conventional statistical models may be tested as part of step S.36, such as regression models (including linear regression models such as partial least squares (PLS) models, and non-linear regression models such as logistic regression models), parametric models, non-parametric models (such as growth models), tree type models or analysis, and neural network-based models. In one embodiment, the models tested by statistical model analyzer 228 may be a wide variety of model types (such as all possible model types). In another embodiment, only a predetermined set of model types may be used (such as only model types that are know or have been proven to be useful statistical models for the type of goal(s) or objective(s) identified).

As illustrated in FIG. 3, the results of the models are then analyzed (step S.38). This step may be performed by statistical model analyzer 228 of model generator 22 (FIGS. 1 and/or 2). In one embodiment, statistical model analyzer 228 may apply one or more benchmark measurements or diagnostic statistics to determine the performance of each model. As can be appreciated by those skilled in the art, conventional benchmark tests or criteria may be applied such as R², AIC and/or BIC. Additionally, or in the alternative, statistical model analyzer 228 may analyze the accuracy of the model with respect to the stated goal(s) for the model. For example, if the object of the model is to provide a forecast or prediction, the error of the model with respect to predicted versus actual values may be computed using, for instance, the following relationship: Error=|(Predicted−Actual)/Actual|. Other metrics (such as false-negative ratios or false-positive ratios) may be used by statistical model analyzer 228 to gauge the performance of the model. By way of a non-limiting example, assume for instance that the object of the model is to predict an event such as charge-off or bankruptcy. In such a case, the performance of the model may be gauged according to sensitivity (i.e., the ability to predict an event correctly) or specificity (i.e., the ability to predict a nonevent correctly). The sensitivity of a model may be determined by analyzing the proportion of event responses that were predicted to be events. The specificity of the model could be determined by analyzing the proportion of non-event responses that were predicted to be non-events.

For comparative analysis, each model may be scored or ranked. In one embodiment, scoring or ranking may be performed by considering the performance and/or accuracy of the models. Various scoring methodologies may be applied to compute a total score for each model. In addition, certain measurements (such as the accuracy of the model with respect to a business goal) may be weighed higher than other measurements (such as performance of the model with respect to statistical goals).

After analyzing the models, the best model(s) are identified (step S.40). This step may be performed by statistical model analyzer 228 of model generator 22 (FIGS. 1 and/or 2). Various approaches may be implemented to identify the best model(s). For example, the model that receives the top ranking could be identified to the user as the best model. Alternatively, a predetermined number of the top ranked models (such as the three highest ranked models) could be identified to the operator or user. This approach could facilitate manual review of the results, so that the most optimum model is selected using, for example, the skill or experience of the user.

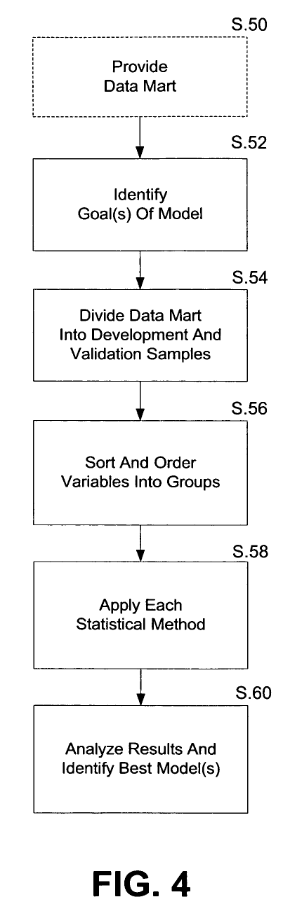

Referring to FIG. 4, another exemplary method for generating statistical models will be described. As with the embodiment of FIG. 3, the exemplary method of FIG. 4 may be implemented using various system environment and components, such as those illustrated in FIGS. 1 and/or 2. Other system environments and platforms may also be used for generating statistical models, consistent with embodiments of the present invention.

As illustrated in FIG. 4, in order to generate a statistical model, a data mart is provided (step S.50). This step may be performed independently or as an integrated step in the overall process of generating statistical models. Further, consistent with embodiments of the invention, the data mart may be initially created and then periodically updated and maintained. For instance, data maintenance may be necessary where the data mart includes time sensitive data, thus requiring certain data to be removed or updated over time. The data mart can also be expanded or enhanced over time, as more data is collected from various sources.

In accordance with one embodiment, the data mart may be provided based on data gathered and stored in a database, such as database 12 (FIG. 1). The creation and maintenance of the data mart may be facilitated by a data module or component, such as data engine 222 (FIG. 2). In one embodiment, large quantities of data may be gathered and stored in database 12 to provide the data mart. As stated above, the data stored in database 12 may be limited to data that is pertinent to a particular field or sector (such as the financial industry or retail sector), or may be relevant to many different industries or sectors and, thus, permit a wider range of models to be generated for a user.

Assume, for example, that the data stored in database 12 is consumer-focused. In such a case, the data stored in database 12 may comprise data relating to thousands or even millions of consumers. Such data may include consumer-related demographic and financial data, and may be collected from various sources (such as public property and tax records, credit reporting agencies, etc.). Moreover, in the context of producing models for an entity that maintains financial accounts for consumers, the data may comprise consumer-related data and/or other data, such as account balance, transaction and payment information.

By way of non-limiting example, the data of database 12 and/or used to create the data mart may be in various data forms, such as cross section, time-series, panel and/or other conventional forms. Such data may include economic data, including data indicating interest rate(s), inflation rate(s), gross domestic product (GDP) and/or other economic data for the United States and/or abroad. Economic data may be collected from various sources such as federal and state government agencies, the Federal Reserve Board, major news reporting agencies, published papers, universities, private data providers and/or institutes that collect economic data. Consumer-related data may also be gathered and stored to create the data mart. For example, consumer credit history data may be gathered from credit bureaus (such as EquiFax, TransUnion, Experian, etc.). Further, consumer demographic, residential and utility payment data may be collected from commercially available data providers or through in-house data collection mechanisms. If relevant, consumer medical and/or disease data may be gathered through agencies such as the Social Security Administration, as well as through data providers and/or in-house data collection techniques. Further, entities such as financial institutions that need to analyze or predict consumer behavior or trends, may collect and store consumer account or statement data (balance, credit limit, payment history, etc.), transaction data (purchases, advances, debits, etc.) and/or non-financial activity (calls to customer services, etc.). Depending on the types of models to be created, additional types of data may also be collected and stored to create the data mart, consistent with embodiments of the invention.

The raw data gathered and stored in database 12 may not be statistically clean and may include missing or extreme data. Accordingly, consistent with an embodiment of the invention, the data stored in database 12 may be cleaned to provide a data mart that can be used for generating models. In one embodiment, a data engine (such as data engine 222) may be provided to process and clean data stored in database 12. For example, data stored in database 12 may be analyzed and cleaned using conventional techniques, such as data imputation techniques and/or extrapolation methods. By applying such techniques, data engine 222 may impute missing data and eliminate extreme data. Further, by processing and cleaning stored data, data engine 222 may construct and provide a large data mart for generating statistical models, consistent with the embodiments of the invention.

In accordance with an embodiment of the invention, data may be inspected by, for example, data engine 222 to identify fields that are missing, contain extreme values (reasonable or unreasonable), incorrect or wrong values, and/or other abnormalities. Conventional statistical procedures may be implemented to identify the scope of data issues that need to be addressed. For instance, data engine 222 may process the data by calculating maximums, minimums, standard deviations, and/or percentiles for data having values. For data without values, other techniques may be employed by data engine 222, such as the computation of the frequency of such data. In certain cases, missing data can mean different things. Therefore, all possible explanations should be explored and considered when constructing the data mart.

Consistent with embodiments of the invention, all data issues that are identified may be addressed or resolved as part of the cleaning process. Conventional techniques such as data imputation may be employed for this purpose. For example, data values may be imputed by using a mean value. Thus, for data identified as having extreme values, missing values (e.g., values that are missing and confirmed not to have any other meaning, such as value=0), or wrong values, the mean may be computed to impute that value. Alternatively, data imputation may be achieved through the determination of a maximum, a minimum and/or a median value. In accordance with other embodiments of the invention, other techniques such as regressions or non-parametric methods can be used to clean the data.

Referring again to FIG. 4, when constructing a new statistical model, the goal(s) or objective(s) of the model is identified (step S.52). As indicated above, the goal(s) of the model may be entered through an interface, such as user interface 32 (FIG. 1). Each model to be generated may have one or more goals or objectives. For example, a statistical model may have a goal or objective such as providing an estimate of whether a consumer will purchase a product. Alternatively, for entities that manage risk associated with financial accounts (such as credit card accounts or loans issued or maintained by a financial entity), the goal of the model may be to predict the likelihood of customer default or account charge-off.

Dependent variables are often referred to as “targeted variables” and are the variables that statistical models are built on and generate predictions. Consistent with an embodiment of the invention, the goal(s) or objective(s) of a model may be coded as dependent variable(s) for the model. Such coding may be performed as part of step S.52, consistent with the stated goal(s) or objective(s) for the model. When coding a dependent variable, a code (e.g., 0, 1, 2, etc.) may be assigned for each possible outcome. For example, if the objective of the model is to predict bankruptcy, dependent variable coding may performed such that: 0=never filed for bankruptcy; and 1=filed for bankruptcy. Other types of outcomes also may be coded, including those that are time dependent. For instance, if the objective of the model is to estimate if a customer makes timely payments, coding may be performed whereby: 0=during the last six months, the payer was late less than two times; 1=during last six months, the payer was late at least two times, but ultimately paid amount owed; etc.

Before analyzing models for the identified goal(s), the data mart may be divided into a development sample and a validation sample (step S.54). As illustrated in FIG. 4, this step may be performed by a data module or engine (such as data engine 226) as part of the main process flow. Alternatively, step S.54 may be performed as part of data preparation (such as step S.50). The data associated with the development sample may be used for developing the model, whereas the data of the validation sample may be used for validating the model. Each sample may represent a predetermined portion of the data mart. Further, the relative size of each portion can be balanced (i.e., 50/50), or unbalanced (60/40, 70/30, etc.). This step may be implemented so as to create two new data marts (i.e., one representing the development sample and one representing the validation sample). Alternatively, this step may simply create new view(s) to or instance(s) of the existing data mart.

As further illustrated in FIG. 4, independent variables may be sorted and ordered into groups (step S.56). This step may be performed to facilitate the application of data from the data mart to each statistical model. As shown in FIG. 4, this step may be performed as part of the main process flow (i.e., following step S.52). Alternatively, step S.56 may be performed during data preparation (such as step S.50). To group the independent variables represented in the data mart, a data module or component (such as data engine 222) may be used. Groups may be defined according to the goal(s) or objective(s) of the model, or groups may be predetermined according to different areas of application (e.g., marketing, finance, sales, human resources, etc.). Assume, for example, that a financial entity wants to generate a statistical model for estimating default rates or charge-offs for a group of accounts (such as credit card accounts). In such a case, variables may be organized into groups such as “Assets” or “Liabilities,” as well as other groups. In addition to sorting variables into groups, the variables may also be ordered or numbered within each group. For instance, the Assets group may include Variables 1-10 and the Liabilities group may include Variables 11-18. In one embodiment, all variables represented in the data mart may be sorted into a group. If a variable does not fit within a main group, then the variable may be placed into a “Miscellaneous” or “Others” group.

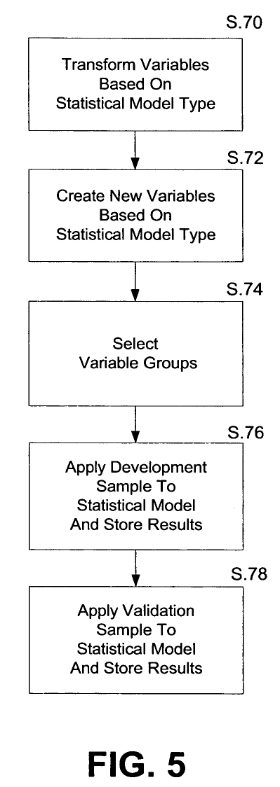

To generate a statistical model, a number (N, where N is an integer greater than 0) of statistical model types can be tested using data from the data mart. To test the statistical models, a number of statistical methods N may be applied, one for each statistical model type (step S.58). A wide variety of conventional model types (such as regression models, parametric models, tree type models, etc.) may be tested to identify the best suited model(s). Generally, for each statistical method, groups of variables from the development sample may be applied to a statistical model type. In addition, groups of variables from the validation sample may be applied to the statistical model. The results from each sample may then be stored for later analysis. An exemplary method for performing step S.58 of FIG. 4 is described below with reference to FIG. 5.

As further illustrated in FIG. 4, the results from each of the applied statistical methods may be analyzed to identify the best model(s) according to the stated goal(s) or objective(s) (step S.60). This step may be performed by a statistical model analyzer, such as statistical model analyzer 228 of model generator 22 (FIGS. 1 and/or 2). In one embodiment, one or more benchmark measurements or diagnostic statistics may be used to determine the overall performance of each statistical model type. As described above, conventional benchmark tests or criteria may be applied, such as R², AIC and/or BIC. Additionally, or in the alternative, statistical model analyzer 228 may analyze the accuracy of each model with respect to the stated model goal(s).

To perform comparative analysis, each model may be scored or ranked. In one embodiment, scoring or ranking may be performed by considering the performance and/or accuracy of the models. Various scoring methodologies may be applied to compute a total score for each model. In addition, certain measurements (such as the accuracy of the model with respect to a business goal) may be weighed higher than other measurements (such as performance of the model with respect to statistical goals).

By analyzing the results of each statistical model type, the best model(s) may be identified. As described above, various approaches may be implemented to identify the best model(s). For example, the model that receives the top ranking could be identified to the user as the best model. Alternatively, a predetermined number of the top ranked models (such as the three highest ranked models) could be identified to the operator or user. This approach could facilitate a certain level of manual review so that the most optimum model is selected using, for example, the expertise or experience of a statistician or user.

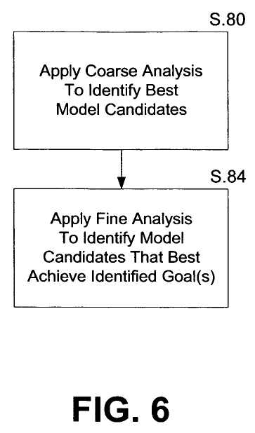

An exemplary method for analyzing and identifying the best model(s) is described below with reference to FIG. 6. As can be appreciated by those skilled in the art, other techniques and methods may be applied to analyze results and identify the best-suited models.

Referring now to FIG. 5, an exemplary method for applying statistical methods will be described, consistent with embodiments of the invention. The exemplary method of FIG. 5 may be performed by model generator 22, using for example data engine 222, model engine 226, and/or model analyzer 228. The exemplary method of FIG. 5 may be implemented as part of step S.58 in the embodiment of FIG. 4 and performed for each of the N statistical models to be tested using the data mart. Thus, steps S.70 through S.78 of FIG. 5 may be repeated to apply each of the N statistical methods.

As illustrated in FIG. 5, one or more independent variables may be transformed based on the statistical model type to be applied (step S.70). For example, certain variables (such as “Balance”) may need to be transformed (such as log(Balance)) for a particular model type. In addition, one or more new variables may be created based on the model type (step S.72). For instance, new variables (such as ratios, averages, etc.) may be created from original variable designations. In one embodiment, the transformation and creation of variables may be performed by a component or module (such as data engine 222 or model engine 226) and stored (such as in random access memory (RAM)) for each statistical model to be tested. In such a case, the transformation and/or creation of new variables may not alter the original data permanently stored in the data mart.

As part of steps S.70 and S.72, the transformed and/or new variables may be sorted into groups. Such grouping may be performed in a similar fashion to the general grouping of variables of the data mart (see step S.56 in FIG. 4). By way of example, all variables (including new and original variables) may be sorted into groups. When sorting variables into groups, all of the variables may be re-numbered or ordered. In another embodiment of the invention, new groups may be created for each statistical model tested and, additionally or optionally, the general grouping of variables (step S.56) may be skipped. In still another embodiment of the invention, new and transformed variables may be sorted and stored into the existing groups of the data mart.

Independent variables may be analyzed and selected for each model type to be tested (step S.74). As part of this step, all variables or groups of variables that are found to be significant to the goal(s) of the model may be selected using, for example, model engine 226 of statistical model generator 22. In one embodiment, different goals or objectives may be categorized and set(s) of variables may be correlated with each category of goals. In such a case, based on the identified goal(s), set(s) of variables may be selected by model engine 226. Other techniques and processed may also be employed by model engine 226 to select variables for each statistical model type to be tested. For example, as indicated above, model engine 226 may first perform a variable reduction routine and then select relevant variables for each model to be tested. Variable reduction may be performed to eliminate statistically redundant data, etc. in the data mart through conventional techniques, such as factor analysis, principal component and variable clustering. Model engine 226 may then identify the most relevant variables for each model analyzed. Stepwise methods or other conventional techniques may be employed by model engine 226 to select the most relevant variables or variable groups. In such a case, variables meeting a minimum threshold may be put into the model.

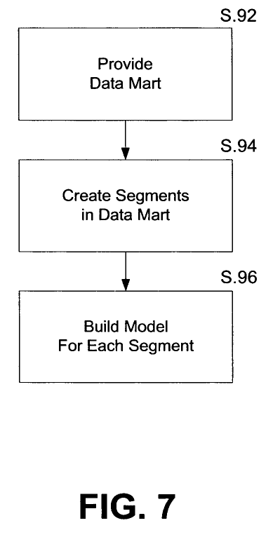

Based on the selected independent variables, historical data is applied from the development sample to each statistical model type (step S.76). Data from the development sample that correspond to the selected variables or variable groups (including new and/or original variable groups) may be applied to a statistical model by model analyzer 228. As can be appreciated by those skilled in the art, conventional statistical techniques may be used by model analyzer 228 for applying data and testing each model. In addition, a conventional segment technique may be used to apply data from one or more segments (such as business segments) of the data mart. Segmentation of the data mart may permit different segments to be analyzed in parallel in order to develop a model for each segment. An exemplary embodiment of the invention that employs segmentation is described below with reference to FIG. 7.

After applying the development sample to the model, all model specifications may be stored for further analysis. For example, all model parameters (including the functional form of the model) and model assessment statistics may be stored. In addition, a model identification number may be assigned for each model tested. The assignment of a model identification number may facilitate storage of the model specifications, as well as the analysis, comparison and identification of the best suited model(s) for the identified goal(s) (see, for example, step S.60 in FIG. 4). Identification numbers for each model also facilitates other capabilities, such as model reassessment or refreshing capabilities. An exemplary embodiment of the invention for providing model refreshing capabilities is further described below.

Data from the validation sample may then be applied to a statistical model type (step S.78). The validation sample may be applied by statistical model analyzer 228 to score each developed model. As can be appreciated by those skilled in the art, scoring of the model permits the model to be assessed for accuracy or performance. In one embodiment of the invention, historical data from the validation sample may be applied by model analyzer 228 to calculate the dependent variable(s) for each developed model. Assume, for example, a model defined as: Y=a+βX, where Y is a dependent variable (such as a dependent variable for predicting bankruptcy), and a, β and/or X are independent variables or coefficients. Using the historical data of the validation sample, model analyzer 228 may apply data to the model corresponding to the independent variables (X) in order to determine the dependent variable (Y). This may be performed for each instance (such as an account or individual customer) represented in the validation sample. The calculated outcome (dependent variable Y) for each account or customer may then be compared with historical data. Further, all scoring results may then be stored for assessment or measurement purposes later on.

FIG. 6 is a flowchart of an exemplary method for analyzing results and identifying the best model(s), consistent with embodiments of the invention. The exemplary method of FIG. 6 may be performed by, for example, statistical model analyzer 228. The exemplary method of FIG. 6 may be implemented as part of step S.60 in the embodiment of FIG. 4.

As illustrated in FIG. 6, a coarse analysis may first be applied to identify the best model candidates (step S.80). The coarse analysis may involve the use of conventional benchmark measurements or diagnostic statistics. For example, in accordance with one embodiment, one or more benchmark measurements may be applied to determine the performance of each model. As can be appreciated by those skilled in the art, conventional benchmark tests or criteria may be applied, such as R², AIC and/or BIC. Additionally, or in the alternative, statistical model analyzer 228 may analyze the accuracy of the model with respect to the goal(s) for the model. For example, if the object of the model is to provide a forecast or prediction, the error of the model with respect to predicted versus actual values may be computed using, for instance, the following relationship: Error=|(Predicted−Actual)/Actual|.

Depending on the object of the model, other conventional metrics (such as false-negative ratios or false-positive ratios) may also be used by statistical model analyzer 228 to gauge the performance of the model. For instance, if the object of the model is to predict an event, such as charge-off or bankruptcy, the performance of the model may be gauged according to sensitivity (i.e., the ability to predict an event correctly) or specificity (i.e., the ability to predict a nonevent correctly). The sensitivity of a model may be determined by analyzing the proportion of event responses that were predicted to be events. The specificity of the model could be determined by analyzing the proportion of nonevent responses that were predicted to be nonevents.

In accordance with an embodiment of the invention, as part of step S.76, all models that are determined by model analyzer 228 to pass a predetermined threshold may be identified as model candidates. Further, all model candidates may be scored or ranked, with the top ranking models (such as the top three or ten models) being identified as the best model candidates.

After identifying the best model candidates, a fine analysis may be performed to identify the model candidates that best achieve the identified goal(s) (step S.84). The fine analysis may be an automated process that further analyzes the model candidates with respect to other parameters and/or actual data to identify an optimum model. Alternatively, a manual review of the identified model candidates may be performed by a statistician or operator who applies skill or experience to select the best model(s). In either case, the model parameters for the best model(s) may be stored and/or reported to the user.

By way of non-limiting example, and to demonstrate how models can be generated consistent with embodiments of the invention, assume a financial account issuer such as a credit card company wants to build models for the purposes of predicting credit card charge-off or bankruptcy over a twelve month span. In this example, a data mart would first need to be provided. To this end, data may be collected and stored in a database, such as database 12 in FIG. 1. Such data may include customer account data, credit bureau data and economic and industry data. Various sources may be used to collect the data for the data mart and some of the collected data may be summarized (if needed). Table 2 provides an example of the types of data sources and corresponding data that could be collected for the noted credit card example. Such data may be collected and stored for each credit card customer (e.g., distinguished by account number, etc.).

TABLE 2

| | | | In-House | | |
|---|---|---|---|---|---|
| | In-House | In-House | Summarized | | |
| | Statement | Statement | Transaction | Credit Bureau | Economic and |
| Data Source | Variables | Variables | Tables | Data | Industry Data |
| Examples | Account | Credit line, | Number of | Number of | Three month |
| of | number, | balance, | purchases | mortgages, | T-bond yield, |
| Variables | etc. | open-to- | this month, | number of | total industry |
| | | buy, APR, | total amount | credit cards, | solicitations |
| | | account | purchased | total debt, | mailed, rate of |
| | | age, etc. | this month, | etc. | inflation, etc. |
| | | | etc. | | |

In the above-noted example, the data that is collected may be cleaned by data engine 222 in order to impute missing, invalid and/or extreme values. This step and other data preparation steps may be performed to provide a clean, large-scale data mart for generating models. For instance, data creation and transformation may be conducted. Various values may need to be transformed or created from existing variables. For example, data representing customers' credit lines may be reclassified into high, medium and low, and assigned a value of 1, 2 and 3, respectively. Further, additional variables may be created based on existing variables. In the above-noted example, the number of purchases over the last three months could be computed by adding the appropriate variables (e.g., number of purchases per month) for the last three months. Dummy variables may also be created where necessary. For instance, if an account does not have a mortgage value, then a mortgage dummy variable may be assigned a value of 0, otherwise it may take a value of 1. Moreover, as part of preparing the data, certain variables may need to be transformed into another form (e.g., by taking the log of a credit line, etc.). As discussed above, the creation and transformation of variables may depend on the type of statistical model to be tested.

To facilitate the processing and analysis of data from the data mart, variables may be grouped and ordered in a consistent format. In the above-noted credit card example, variables could be grouped according to data source, with the variables consecutively number (e.g., var00001, var00002, . . . var99999). Newly created variables, dummy variables and transformed variables may also be grouped in a similar fashion. In addition, new data or updates to the data mart may be grouped and ordered using the same format. By using a consistent format, the data mart may be grouped and ordered only once, with updates subsequently added. For purposes of illustration, Table 3 provides an example of grouping and ordering the variables from Table 2.

TABLE 3

| | | | In-House | | |
|---|---|---|---|---|---|
| | In-House | In-House | Summarized | Credit | |
| Data | Statement | Statement | Transaction | Bureau | Economic and |
| Source | Variables | Variables | Tables | Data | Industry Data |
| Examples | var00001 | var00002, | var00201, | var02001, | var05001, |
| of | | var00003, | var00202, | var02002˜var05000 | var05002, |
| Variables | | ˜var00200 | ˜var02000 | | ˜var06000 |

To facilitate use and maintenance of the data mart, information may be collected and stored during preparation of the data mart. For example, in accordance with one embodiment of the invention, variable renaming reports, data value reports and other information may be collected and stored. Such reports may be stored and maintained by, for example, data engine 222.

As further disclosed herein, the data in the data mart may be segmented according to various objectives. If employed, segmentation may permit data in the data mart to be meaningfully organized (e.g., by customer status, account type, etc.). As a result, models can be generated during the modeling process for each segment. Various methods may be used to create segments, including the exemplary embodiment described below with reference with reference to FIG. 7.

In the above-noted credit card example, segment variables may be created to serve as a flag for the modeling process to build models according to the defined segments. With the data mart segmented, segmentation variables (e.g., seg00001, seg00002, etc.) may be created for each of the created segments. Table 4 illustrates an example of how the data mart of Table 3 could be segmented into a number of segments (i.e., seg00001 through seg00100).

TABLE 4

| | | | In-House | | Economic | |
|---|---|---|---|---|---|---|
| | In-House | In-House | Summarized | Credit | and | |
| Data | Statement | Statement | Transaction | Bureau | Industry | Segment |
| Source | Variables | Variables | Tables | Data | Data | Variables |
| Examples | var00001 | var00002, | var00201, | var02001, | var05001, | seg00001, |
| of | | var00003, | var00202, | var02002˜var05000 | var05002, | seg00002, |
| Variables | | ˜var00200 | ˜var02000 | | ˜var06000 | ˜seg00100 |

Before building models based on the data mart, coding of dependent variables may be performed. As disclosed herein, dependent variables are target variables and, generally, the variables upon which statistical models are built. In the credit card example, the goal is to build one or more types of models (e.g., charge-off and bankruptcy models over a twelve month span). For the purposes of coding historical data related to each customer account, the account may be flagged and the necessary dependent variables may be created. For instance, if over a twelve month span, an account is charge-off but not bankrupt, then dep001=1; otherwise, dep001=0. If over a twelve month span, an account is bankrupt, then dep002=1; otherwise, dep002=0. If the credit card company wants to build attrition models or profit models, all that is necessary is to code more and more dependent variables (as needed). In one embodiment, the coded dependent variables may be stored with the data mart, as exemplified below in Table 5.

TABLE 5

| | | | In-House | | Economic | | |
|---|---|---|---|---|---|---|---|
| | In-House | In-House | Summarized | Credit | and | | |
| Data | Statement | Statement | Transaction | Bureau | Industry | Segment | Dependent |
| Source | Variables | Variables | Tables | Data | Data | Variables | Variables |
| Examples | var00001 | var00002, | var00201, | var02001, | var05001, | seg00001, | dep001, |
| of | | var00003, | var00202, | var02002˜var05000 | var05002, | seg00002, | dep002, |
| Variables | | ˜var00200 | ˜var02000 | | ˜var06000 | ˜seg00100 | ˜dep020 |

Various model types may be analyzed and tested for generating a model that is best suited for the identified goal(s). By way of non-limiting example, the model may take the general form: dependent variable=F(independent variables), where F( ) stands for a functional form, such as linear, non-linear or other forms. For purposes of illustration, assume the linear form: dependent variable=a+b₁·variable₁+b₂·variable₂+ . . . +bᵢ·variableᵢ, where a is an intercept, b₁ through bᵢ are coefficients, and variable₁ through variableᵢ are independent variables. As disclosed herein, other model forms or types may also be used for generating models, consistent with embodiments of the present invention.

In the above-noted credit card example, the variables (var00001 through var06000) could be potentially correlated and thus statistically redundant. Thus, to use all variables in the data mart may not only be inefficient, but may also cause multi-collinearity. Accordingly, the variable selection techniques of the present invention may be used to reduce the number of variables considered in the model building process. Various conventional techniques, such as factor analysis, principle component, and variable clustering, may be used for this purpose. For information concerning factor analysis, see for example: McDonald, R. P., Factor Analysis and Related Methods, Lawence Erlbaum Associates, New Jersey (1985); and Rao, C. R., “Estimation and Test of Significance in Factor Analysis,” Psychometrika, Vol. 20, pp. 93-111 (1955). For information regarding principle component techniques, see for example: Cooley, W. W. and Lohnes, P. R., Multivariate Data Analysis, John Wiley & Sons, Inc., New York, N.Y. (1971); and Mardia, K. V., Kent, J. T., and Bibby, J. M., Multivariate Analysis, Academic Press, London (1979). Further, for information concerning variable clustering, see for example: Anderberg, M. R., Cluster Analysis for Applications, Academic Press, Inc., New York (1973); Harman, H. H., Modern Factor Analysis, Third Edition, University of Chicago Press, Chicago, Ill. (1976); and Hand, D. J., Daly, F., Lunnn, A. D., McConway, K. J., and Ostrowski E., A Handbook of Small Data Sets, Chapman & Hall, London, pp. 297-298 (1994). The relevant portions of each of the above references are hereby incorporated by reference in their entirety.

In addition to the above-mentioned processing, the data mart may be divided into development and validation samples prior to entering the model building process. By way of illustration, the entire data mart for the credit card example may be divided into a 50/50 or 70/30 (if 50/50 is not feasible) allocation between development and validation samples. As described above, data from the development and validation samples may be applied by the model analyzer 228 to identified the best-suited models, by testing a plurality of model types. In addition, if the data mart is segmented, division of the data into development and validation samples may be performed before or after segmentation is performed. In one embodiment, each segment of the data mart may be divided into development and validation samples. In another embodiment, if for example the data mart includes segments that are small in size, then the division of the data into development and validation samples may be performed after segmentation.

In the noted credit card example, a number of model types may be tested for generating models for predicting charge-off and bankruptcy for each segment represented in the data mart. For example, logistic regression, neural network and tree analysis models may be analyzed using the variables from the development sample. Further, the developed models for each segment may be scored using the corresponding validation sample.

To identify the best-suited models, the results may be analyzed by statistical model analyzer 228. For instance, as part of a coarse grain analysis, various business measurements may be used to compare model performance. In the credit card example, a business ratio may be defined such as the number of actual charge-off accounts versus number of predicted charge-off accounts. Any models determined to do better than or equal to a predetermined threshold (such as 5%), may be determined to qualify for further analysis and final model selection. Alternatively, conventional statistical measures or criteria (such as AIC, BIC, etc.) may be used to gauge performance. In such a case, threshold measures may also be specified to select models during the coarse analysis.

For final model selection, a fine analysis of the results may be performed. This step may be automated or assisted by the analysis of a statistician or skilled user. A number of factors may be considered during fine analysis of each of the models selected during the coarse analysis. For instance, a check can be made that all business and statistical measures from the last stage are valid. Further, the functional form and meaning of the resulting model may be checked to confirm that they are valid. This may include checking that the variables and coefficients entered into the model are meaningful and useful. As an additional check, the model may be analyzed to verify that it meets the identified goal(s) or objective(s). From the fine grain analysis, the best-suited model(s) may be identified and the associated parameters of the model(s) stored and reported to the user.

With reference to FIG. 7, an exemplary embodiment of the invention that employs segmentation will now be described. Consistent with embodiments of the invention, FIG. 7 illustrate an exemplary flowchart for generating models from a data mart or database organized into segments. The features of FIG. 7 may be implemented in various system environments, such as the exemplary system environment of FIG. 1. Further, the exemplary components of FIG. 2 may be adapted to perform the embodiment of FIG. 7. In one embodiment, data engine 222 is adapted to create a data mart with segments (see step S.94 in FIG. 7). In another embodiment, a separate segmentation engine (not shown) may be provided along with the components of statistical model generator 22 to provide segmentation capabilities.

As shown in FIG. 7, a data mart is initially provided (step S.92). Consistent with embodiments of the invention, step S.92 may be performed independently or as an integrated step in the overall process of generating statistical models. For example, similar step S.50 of the embodiment of FIG. 4, a data mart may be provided based on data gathered and stored in a database, such as database 12 (FIG. 1). As part of step S.92, the data mart may also be cleaned by data engine 222 (FIG. 2). In addition, other data preparation steps may be performed, such as dividing the data mart into development and validation samples (step S.54 in FIG. 4) and/or sorting variables into groups (step S.56 in FIG. 4). Alternatively, all data preparation steps (including the cleaning of data) may be performed on each segment following step S.94 (i.e., after the segments in the data mart have been created).

Based on the data stored in the data mart, segments may be created (step S.94). For example, using data engine 222 or a segmentation engine (not shown) of model generator 22, segments may be defined and created in the data mart. Segmentation of the data may permit the data in the data mart to be segmented according to one or more objectives, such as business objectives, statistical objectives and/or other objectives. Thus, for example, segments may be defined according to various characteristics, such as business unit or region, account type, customer profile, etc. The objective(s) that control segmentation may be provided as input from a user or operator (such as through interface 32 in FIG. 1). In addition, through user interface 32, a user or operator may also be permitted to review, modify or change the segments created in the data mart.

When creating segments in the data mart, segment identification numbers may assigned to each segment. For example, if segments are created according to customer status, then for each customer record or set of customer data a segment identification number may be assigned (e.g., segID0001=0 for preferred status and segID0001=1 for non-preferred status; segID0002=0 for high credit risk, segID0002=1 for medium credit risk, and segID0002=2 for low credit risk; etc.). For global data or other data in the data mart that does not fit within any of the defined segments, such data may not be segmented. However, such data may still be considered (e.g., as a global, independent variable) when constructing models for specific segments.

After creating segments in the data mart, a model may be generated for each segment (step S.96). Consistent with embodiments of the invention, models may be generated for each segment using statistical model generator 22. The identified goal(s) for each model may be identical (such as predicting bankruptcy or charge-off), or a user may be permitted to identify goal(s) for the model of each segment. In the later case, the goal(s) may be unique or overlap between segments. In cases where a large number of segments are generated, models may be generated for more than one segment (especially where segments are found to be similar or a model is deemed to be applicable to more than one segment). To reduce the number of segments analyzed, the distribution of variables in the segments may be compared using conventional distribution analysis methods, such as a T-test. For further information concerning T-tests, see for example: Lee, A. F. S. and Gurland, J., “Size and Power of Tests for Equality of Means of Two Normal Populations with Unequal Variances,” Journal of the American Statistical Association, Vol. 70, pp. 993-941 (1975); Posten, H. O., Yeh, Y. Y., and Owen, D. B., “Robustness of the Two-Sample T Test Under Violations of the Homogeneity of Variance Assumption,” Communications in Statistics, Vol. 11, pp. 109-126 (1982); and Yuen, K. K., “The Two-Sample Trimmed t for Unequal Population Variances,” Biometrika, Vol. 61, pp. 165-170 (1974), the relevant portions of which are hereby incorporated by reference.

By way of non-limiting example, and to further demonstrate how segmentation may be performed, assume an entity such as a credit card company has a large number of accounts, such as 43 million accounts. These 43 million accounts may represent consumers with different credit quality. One statistical model may be built for all of the accounts. Alternatively, consistent with an embodiment of the invention, segments may be constructed from these accounts and models may be generated for each segment. To build a model for each segment, the features of the embodiment of FIG. 3 (see steps S.32 to S.40) or the embodiment FIG. 4 (see steps S.52 to S.60) may be employed as part of step S.96. Additionally, the exemplary features and techniques of the embodiments FIGS. 5 and 6 can be implemented, consistent with the teachings of the present invention.

As indicated above, segments may be created based on various objectives, such as business and/or statistical objectives. These objectives may be defined by the user or according to the needs of a business entity. For example, returning to the previous example, the credit card company may categorize the 43 million accounts according to business objectives. Thus, accounts may be defined according to type (such as prime accounts, sub-prime accounts, etc.). Using these account definitions, data engine 222 or a segmentation engine may segment all of the accounts represented in the data mart. Models may then be generated for each segment represented in the data mart, such that one model is generated for prime accounts and another model for sub-prime accounts.

Statistical objectives may also be used to segment a data mart. For instance, in the credit card company example, a consumer's credit line may be statistically significant and used to segment accounts. By way of non-limiting example, credit lines may be segmented into low, medium, and high line categories. For example, a low credit line may be defined as $1000 or lower; a medium credit line defined as $1000-$5000; and a high credit line may be defined as $5000 or more. Using these definitions, each account may be segmented into low, medium, and high line categories. Thereafter, one model may be built for each credit line category.

Segments may also be created based on both business and statistical objectives. For example, for each prime or sub-prime account, there may also be low, medium, and high credit line accounts. Thus, in the above-noted credit card example, prime accounts may have low, medium, and high credit line accounts, and sub-prime accounts as well. With the combination of prime/sub-prime accounts and credit line categories, six different segments may be defined and created in the data mart. As a result, statistical model(s) may be built for each of the six segments according to one or more identified goal(s).

Other characteristics or dimensions may be used to further divide segments and build more models. Accordingly, if desired, hundreds, thousands or even millions of segments and corresponding models may be generated. As can be appreciated by those skilled in the art, the automated modeling processes and techniques of the present invention make such model building needs feasible.

In certain circumstances, a practical concern may arise that too many segments and, hence, too many models are to be built. Therefore, reducing the number of segments may become necessary. Consistent with embodiments of the invention, various techniques may be employed to reduce the number of segments. For example, as disclosed herein, one way to reduce the number of segments is to compare the distributions of key variables from each segment. For this purpose, a T-test may be employed to test the difference or similarity in distributions. Other conventional techniques may also be employed and, thus, the methods used in reducing segments is not limited to this example.

Although segmentation has been described with reference to a credit card example, segmentation may be applied to other fields than the credit card industry. By way of non-limiting example, various key variables may be identified to create segments from the data mart. For instance, for consumer-orientated entities such as retailers, variables including age, sex, and/or income may be key driving variables to generate models for considering spending and shopping patterns of customers. For example, a retailer may create three categories of age (such as: up to 18, 18-60, and 60+); two categories of sex (such as: male and female); three categories of income (such as: up to $35,000 annually, $35,000-$100,000, and $100,000 or more). Such an approach could be used to create eighteen segments and, according to the embodiment of FIG. 7, a model may be generated for each segment.

Other embodiments of the invention will be apparent to those skilled in the art from consideration of the specification and practice of the invention disclosed herein. For example, embodiments of the invention may be adapted to provide refresh capabilities, whereby developed models are reassessed or analyzed using updated or new data from a data mart. Additionally, parallel or multi-processing techniques may be employed to get a plurality of statistical models at a time, wherein each model has a different set of goal(s) or objective(s).

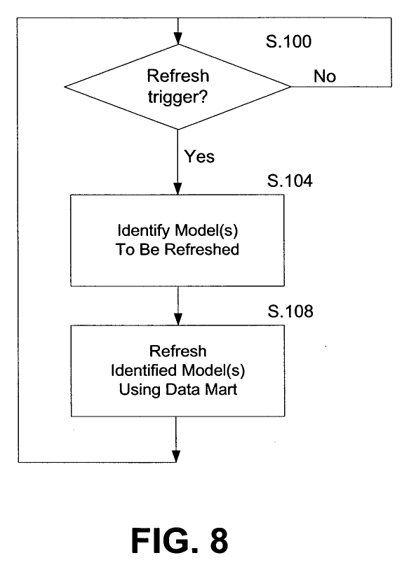

With reference to FIG. 8, an exemplary embodiment for providing model-refreshing capabilities will now be described. FIG. 8 illustrates a flowchart of an exemplary method for refreshing models, consistent with embodiments of the invention. Model-refreshing capabilities can be combined with the embodiments of FIGS. 1-7 to facilitate the maintenance or update of models. As can be appreciated by those skilled in the art, the accuracy of a statistical model may deteriorate over time and/or due of various factors (such as inflation, the availability of alternative products, fluctuations in market prices, consumer behavior trends, etc.). Thus, there is a need to update and refresh statistical models periodically and efficiently.

As shown in FIG. 8, the process may begin by monitoring for a model-refreshing trigger (step S.100). The monitoring of triggers may be performed by a refresh module or control engine (not shown) that is provided as part of statistical model generator 22 or as a separate software-based module. Various factors may be used for triggering model-refreshing. For instance, models may be refreshed periodically over time and/or whenever there is an update to the data mart. In accordance with one embodiment of the invention, a predetermined cycle (such as one month) may be set for refreshing models. In another embodiment, data engine 222 may issue a signal to the refresh module or control engine to indicate when updates have been made to the data mart. As can be appreciated by those skilled in the art, more than one factor may be used for triggering model-refreshing.

When a refresh trigger is detected (step S.100; Yes), identification may be made as to which models should be refreshed (step S.104). Since a refresh trigger may not affect all models, an analysis can be made by the control module or refresh module to determine which models need to be refreshed. Depending on the nature of refresh trigger, only portion of the models may need to be refreshed. For instance, different predetermined cycles (one month, two months, etc) may be set for different models. Additionally, data updates to specific segments in the data mart may only affect certain models (e.g., the models generated for those segments). In addition, in some cases, all models may need to be refreshed. For example, changes to global or economic data in the data mart may trigger model-refreshing for all models. Once a determination is made as to the nature of the refresh trigger and scope of models affected, the control module may identify the models to be refreshed. In accordance with one embodiment, each model is assigned a model identification number. With the model identification number, each model may be identified (when necessary) and the necessary model parameters and characteristics retrieved for refreshing.

As further illustrated in FIG. 8, each of the identified models are refreshed (step S.108). Refreshing may be performed by the refresh module or control engine by applying data from the data mart to the model. In one embodiment, a control engine may specify threshold values for various statistical measurements. Using such values, the performance of the model may be analyzed to determine if the accuracy or specificity of the model has deteriorated or remained sufficient. Models that are found not to satisfy minimum threshold requirements may rejected. When a model is found not to be sufficient, a new model may be generated or the existing model may be further examined and modified to provide satisfactory results. Reports reflecting the results of model-refreshing may be generated for each model tested. Model refresh reports may be stored for future analysis and comparison.

As can be appreciated from the foregoing description, embodiments of the invention provide numerous advantages over past approaches. For instance, in contrast to traditional modeling process that rely heavily on textbook examples and manual intervention, embodiments of the invention provide an automated approach to model building. Further, consistent with embodiments of the invention, a comprehensive model generator may be provided (such as statistical model generator 22). The comprehensive model generator may be implemented to perform most of the steps involved in the model building process, including variable imputation and transformation, variable selection, model analysis and selection, and/or model production. Such a comprehensive model generator can be advantageously employed by business entities (such as credit card companies), particularly where only a handful of statistical methods may be relevant and proven to work for most business modeling needs. In such cases, there is no business or academic study is needed. With a comprehensive model generator coded in advance based on the proven statistical methods, the remaining tasks of model building may be reduced down to organizing relevant data to feed the model generator. Such an approach may permit business to generate models more efficiently using a comprehensive approach never seen before in prior traditional model building processes.

Embodiments of the invention may also be advantageously used for other purposes. For instance, various business units of a corporation may often try to model the same behavior but for different populations. By way of example, various business units of a credit card company may be interested in the charge-off behavior of different customer populations (such as super-prime, prime, and sub-prime customers). There is, however, little reason to build models separately using traditional approaches. In practice, it is proven that the data sources, variable imputation and transformation should be done in the exactly same fashion. Although the final models may be different, the data used to feed and the statistical methods used in the model building process should be the same. Using the exemplary methods and systems of the present invention, companies are provided with a model building approach that permits multiple models for various business units to be built concurrently. Such an approach reduces the cost of model building and achieves a greater efficiency.

Other advantages are also apparent from practicing the embodiments of the present invention. For example, using the exemplary model building methods and systems of the invention, a user can increase the chance of finding a global optimal model. As disclosed herein, embodiments of the invention may be implemented to test and analyze large quantity of models by accounting for every potentially useful model type. Further, various screening methods may be employed to analyze and select the best model(s) for use. Thus, there is an increased chance that the final model(s) will achieve a global optimum when comparing all final model candidates. In contrast, most traditional model building process can only achieve a global optimum by chance.

Moreover, embodiments of the invention allow companies and business to model each key aspect of a customer separately. For instance, a business may be interested in not only a customer's charge-off behavior, but also interested in which behavior drives the customer's charge-off, whether assets or liabilities. By generating multiple models, a business can assign multiple scores to the customer and gain a more complete view of where the customer is financially.

As can be appreciated by those skilled in the art, the present invention is not limited to the particulars of the embodiments disclosed herein. For example, the individual features of each of the disclosed embodiments may be combined or added to the features of other embodiments. In addition, the steps of the disclosed methods herein may be combined or modified without departing from the spirit of the invention claimed herein. Moreover, while embodiments of the invention have been exemplified herein through reference to the credit card and financial industry, embodiments of the invention may be adapted or utilized for other industries or fields.

Accordingly, it is intended that the specification and embodiments disclosed herein be considered as exemplary only, with a true scope and spirit of the invention being indicated by the following claims.

1. A method for generating a statistical model, comprising:
providing a database comprising data representing a plurality of variables;
selecting a set of variables in accordance with a goal for the statistical model;
applying the selected set of variables based on the data from the database to a plurality of statistical model types;
analyzing the results for each statistical model type; and
identifying at least one statistical model based on the analysis of the results.

2. A method according to claim 1, wherein the method further comprises cleaning the data in the database to impute missing or extreme values.

3. A method according to claim 1, wherein the method further comprises coding at least one dependent variable based on the goal of the model.

4. A method according to claim 1, wherein the set of variables comprise independent variables.

5. A method according to claim 4, wherein the method further comprises sorting and ordering the independent variables into groups.

6. A method according to claim 4, wherein selecting a set of variables comprises eliminating statistically redundant data by performing at least one of factor analysis, principal component and variable clustering.

7. A method according to claim 4, wherein selecting a set of variables comprises identifying relevant variables by performing at least a stepwise analysis of the variables.

8. A method according to claim 1, wherein the data representing the set of variables is provided as part of a data mart.

9. A method according to claim 8, wherein the method further comprises dividing the data in the data mart into a development sample and a validation sample.

10. A method according to claim 9, wherein applying the selected set of variables comprises applying data from the development sample to the plurality of statistical model types and applying data from the validation sample to the plurality of statistical model types.

11. A method according to claim 1, wherein applying the selected set of variables comprises applying data from the database to a plurality of statistical models types, including at least one of regression models, parametric models, non-parametric models, tree type models, and neural network models.

12. A method according to claim 1, wherein analyzing the results for each statistical model type comprises applying at least one benchmark measurement to determine the performance of each statistical model type with respect to the goal of the model.

13. A method according to claim 12, wherein applying at least one benchmark measurement comprises performing an analysis of the results using at least one of an R2 computation, Akaike's information criteria (AIC), and Bayesian information criteria (BIC).

14. A method according to claim 1, wherein analyzing the results for each statistical model type comprises ranking model types according to the level of performance of the model with respect to the goal of the model.

15. A method according to claim 14, wherein identifying at least one statistical model comprises selecting the highest ranked model based on performance.

16. A method according to claim 1, wherein the method further comprises segmenting the database and generating a statistical model for each segment of the database.

17. A method according to claim 16, wherein the database is segmented consistent with at least one of business objectives and statistical objectives.

18. A method according to claim 1, wherein the method further comprises refreshing the statistical model after the model is generated.

19. A method according to claim 18, wherein refreshing the statistical model comprises refreshing the model in response to a refresh trigger, the refresh trigger comprising a predetermined event.

21. A method according to claim 19, wherein the predetermined event is at least one of an update to data in the database and a predetermined time period.

22. A system for generating a statistical model, comprising:
a database comprising data representing a plurality of variables;
a statistical model generator to generate statistical models; and
a user interface to receive data and provide output,
wherein the statistical model generator includes means for: applying a set of selected variables, based on the data from the database, to a plurality of statistical model types; means for analyzing the results for each statistical model type; and means for identifying at least one of statistical model based on the analysis of the results.

23. A system according to claim 22, wherein the statistical model generator comprises a data engine that is adapted to clean data in the database in order to impute missing or extreme values.

24. A system according to claim 23, wherein the data engine comprises means for comprises sorting and ordering the variables into groups.

25. A system according to claim 23, wherein the data is arranged as part of a data mart, and wherein the data engine comprises means for dividing the data in the data mart into a development sample and a validation sample.

26. A system according to claim 22, wherein the means for applying a set of selected variables comprises a model engine, the model engine being adapted to select a set of variables in accordance with a goal for the statistical model.

27. A system according to claim 26, wherein the model engine comprises means for eliminating statistically redundant variables by performing at least one of factor analysis, principal component and variable clustering.

28. A system according to claim 26, wherein the model engine further comprises means for identifying relevant variables by performing at least a stepwise analysis of the variables.

29. A system according to claim 22, wherein the means for analyzing the results for each statistical model type and means for identifying at least one of statistical model comprise a statistical model generator.

30. A system according to claim 22, wherein the means for applying the set of selected variables applies data from the database to a plurality of statistical models types, including at least one of regression models, parametric models, non-parametric models, tree type models, and neural network models.

31. A system according to claim 22, wherein the means for analyzing the results for each statistical model type applies at least one benchmark measurement to determine the performance of each statistical model type with respect to a goal of the model.

32. A system according to claim 31, wherein the benchmark measurement is based on at least one of an R2 computation, Akaike's information criteria (AIC), and Bayesian information criteria (BIC).

33. A system according to claim 22, wherein the means for analyzing the results for each statistical model type comprises means for ranking model types according to the level of performance of the model with respect to a goal of the model.

34. A system according to claim 33, wherein the means for identifying at least one statistical model comprises means for selecting the highest ranked model based on performance.

35. A system according to claim 22, wherein the system further comprises means for segmenting the database in accordance with at least one of business objectives and statistical objectives, and wherein a statistical model is built for each segment.

36. A system according to claim 22, wherein the system further comprises means for refreshing the statistical model after the model is generated.

37. A system according to claim 36, wherein the means for refreshing the statistical model refreshes the model in response to a refresh trigger, and wherein the refresh trigger comprising a predetermined event.

38. A system according to claim 37, wherein the predetermined event is at least one of an update to data in the database and a predetermined time period.

39. A computer readable medium that includes program instructions or program code for performing computer-implemented operations to provide a method for generating statistical models, the method comprising:
selecting a set of variables in accordance with a goal of the model;
applying the selected set of variables based on the data from a database to a plurality of statistical model types;
analyzing the results for each statistical model type; and
identifying at least one of the statistical model based on the analysis of the results.

40. A computer readable medium according to claim 39, wherein the program code further comprises program code for cleaning the data in the database to impute missing or extreme values.

41. A computer readable medium according to claim 39, wherein the program code further comprises program code for sorting and ordering the variables into groups.

42. A computer readable medium according to claim 39, wherein selecting a set of variables comprises eliminating statistically redundant data by performing at least one of factor analysis, principal component and variable clustering.

43. A computer readable medium according to claim 39, wherein selecting a set of variables comprises identifying relevant variables by performing at least a stepwise analysis of the variables.

44. A computer readable medium according to claim 39, wherein the data is provided as part of a data mart, and wherein the program code further comprises program code for dividing the data in the data mart into a development sample and a validation sample.

45. A computer readable medium according to claim 44, wherein applying the selected set of variables comprises applying data from the development sample to the plurality of statistical model types and applying data from the validation sample to the plurality of statistical model types.

46. A computer readable medium according to claim 39, wherein applying the selected set of variables comprises applying data from the database to a plurality of statistical models types, including at least one of regression models, parametric models, non-parametric models, tree type models, and neural network models.

47. A computer readable medium according to claim 39, wherein analyzing the results for each statistical model type comprises applying at least one benchmark measurement to determine the performance of each statistical model type with respect to the goal of the model.

48. A computer readable medium according to claim 47, wherein applying at least one benchmark measurement comprises performing an analysis of the results using at least one of an R2 computation, Akaike's information criteria (AIC), and Bayesian information criteria (BIC).

49. A computer readable medium according to claim 39, wherein analyzing the results for each statistical model type comprises ranking model types according to the level of performance of the model with respect to the goal of the model.

50. A computer readable medium according to claim 49, wherein identifying at least one statistical model comprises selecting the highest ranked model based on performance.

51. A computer readable medium according to claim 39, wherein the program code further comprises program code for segmenting the database and generating a statistical model for each segment of the database.

52. A computer readable medium according to claim 51, wherein the database is segmented consistent with at least one of business objectives and statistical objectives.

53. A computer readable medium according to claim 39, wherein the program code further comprises program code for refreshing the statistical model after the model is generated.

54. A computer readable medium according to claim 53, wherein the program code for refreshing the statistical model comprises program code for refreshing the model in response to a refresh trigger, the refresh trigger comprising a predetermined event.

55. A computer readable medium according to claim 53, wherein the predetermined event is at least one of an update to data in the database and a predetermined time period.

56. A method for generating statistical models, comprising:
providing a database comprising data, the data representing a plurality of variables;
segmenting the data in the database into a plurality of segments; and
generating a statistical model for each segment in the database, wherein the statistical model for each segment is generated by:
selecting a set of variables from a segment in accordance with a goal for the statistical model;
applying the selected set of variables based on data from the segment in the database to a plurality of statistical model types;
analyzing the results for each statistical model type; and
identifying at least one statistical model for the segment based on the analysis of the results.

57. A method according to claim 56, wherein segmenting the data in the database comprises segmenting according to at least one of business objectives and statistical objectives.

58. A method according to claim 56, wherein applying the selected set of variables comprises applying data from the segment to a plurality of statistical models types, including at least one of regression models, parametric models, non-parametric models, tree type models, and neural network models.

59. A method according to claim 56, wherein analyzing the results for each statistical model type comprises applying at least one benchmark measurement to determine the performance of each statistical model type with respect to the goal of the model.

60. A method according to claim 59, wherein applying at least one benchmark measurement comprises performing an analysis of the results using at least one of an R2 computation, Akaike's information criteria (AIC), and Bayesian information criteria (BIC).

61. A method for generating and maintaining statistical models, comprising:
providing a data mart comprising data, the data representing a plurality of variables;
generating a plurality of statistical models based on the data in the data mart, each of the statistical models being consistent with an identified goal for the model;
monitoring, after the statistical models are generated, for the occurrence of a refresh trigger;
identifying, in response to a refresh trigger, which of the statistical models need to be refreshed; and
refreshing the statistical models identified to be refreshed.

62. A method according to claim 61, wherein the method further comprises periodically updating the data in the data mart with new data, and wherein refreshing comprises refreshing the statistical models identified to be refreshed with the updated data in the data mart.

63. A method according to claim 61, wherein the refresh trigger comprises the occurrence of a predetermined event.

64. A method according to claim 63, wherein the predetermined event is at least one of an update to data in the data mart and a passing of a predetermined time period.

65. A method according to claim 61, wherein generating the statistical model comprises:
selecting a set of variables from the data mart in accordance with the goal for the model;
applying the selected set of variables based on data from the data mart;
analyzing the results for each statistical model type; and
identifying at least one statistical model based on the analysis of the results.

66. A method of analyzing results of statistical models comprising:
applying a coarse analysis of the results comprising:
applying one or more benchmark measurements to the results of the statistical models,
comparing the results of the statistical models with a preset goal of the statistical models,
identifying the best performing statistical models; and
applying a fine analysis of the results comprising:
checking to ensure that the variables used by the best performing statistical models are accurate.

67. The method of claim 66, wherein applying a fine analysis of the results further comprises:
comparing the best performing statistical models with a predetermined objective.

68. A computer readable medium that includes program instructions or program code for performing computer-implemented operations to provide a method for analyzing results of statistical models, the method comprising:
applying a coarse analysis of the results comprising:
applying one or more benchmark measurements to the results of the statistical models;
comparing the results of the statistical models with a preset goal of the statistical models; and
identifying the best performing statistical models;
applying a fine analysis of the results comprising:
checking to ensure that the variables used by the best performing statistical models are accurate.

69. A computer readable medium according to claim 68, wherein applying a fine analysis of the results further comprises:
comparing the best performing statistical models with a preset goal or objective.

70. A method according to claim 19, wherein refreshing comprises analyzing the model to determine if the model satisfies a set of minimum threshold requirements.
